(19) United States
(12) Patent Application Publication
(10) Pub. No.: US 2026/0169456 A1
(43) Pub. Date: Jun. 18, 2026

(54) SYSTEM AND METHOD FOR GENERATING AN OPTIMAL MOTION CONTROL SIGNAL FOR MACHINE

(71) Applicant: Panasonic Intellectual Property Management Co., Ltd., Osaka (JP)

(72) Inventors: SATYAM ., Singapore (SG); YONGNING YIN, Singapore (SG); KHAI JUN KEK, Singapore (SG); JUNICHI KANO, Osaka (JP); SATOSHI NAKAZAWA, Osaka (JP); YUSUKE KINOSHITA, Kyoto (JP)

(21) Appl. No.: 18/978,028

(22) Filed: Dec. 12, 2024

(51) Int. Cl. G05B 19/23

(52) U.S. Cl. CPC G05B 19/23; G05B 2219/34083

(57) ABSTRACT

Disclosed herein is a method (400) for generating an optimal motion control signal for at least one machine (108). The method (400) includes receiving an input from a UE (102), where the input indicates a trajectory (322) corresponding to a path to be followed by the at least one machine (108). The method (400) includes splitting the trajectory (322) into a plurality of sub-trajectories (324), computing an order, formulating a plurality of factors, and determining solvability. The method (400) includes determining a plurality of constraint violations based on the determined solvability and applying one or more remedial factors, based on the determined plurality of constraint violations. The method (400) includes generating the optimal motion control signal for the at least one machine (108) based on the applied one or more remedial factors.

### FIELD OF THE INVENTION

The present invention generally relates to the field of industrial machines, and more specifically relates to a system and method for generating an optimal motion control signal for at least one machine.

### BACKGROUND

In recent years, an industry, for example, an original equipment manufacturer industry, has been using machines to develop optimal parts/components as required in different sectors for example, the automotive sector, the home appliances sector, etc. Typically, a machine performs different operations, for example, cutting, milling, drilling, or other processes to form the optimal part/components. The machine, to perform different operations, is configured to follow precise trajectories, which align with a shape and size of the part/components to be formed. The trajectories and the different operations are defined by a programmer, on a user equipment, for example, a laptop/computer, etc., with various means, for example, programming. Further, the trajectories and different operations are translated into a language that is understandable by the machine using different software. Thereafter, the machine with the help of a control unit follows the precise trajectories to perform the different operations.

However, the machine while following the precise trajectories suffers limitations, that, the machine, sometimes, experiences difficulty while traversing over the trajectories as defined. This results in the vibration which consequently induces jerking movement in the machine. This affects the precision of the optimal part/components to be formed. To overcome this problem, many technical solutions have been developed. In a known technique, a system for controlling the speed of a control unit of a machine is disclosed. In this system, the control unit is operated at a lower speed as compared to a normal speed of the control unit which results in the elimination of vibration. However, this configuration leads to another problem, such as increased takt time which impacts the overall efficiency of the machine.

Therefore, there lies a need for an improved method and system capable of generating an optimal motion control signal for a machine while ensuring the takt time of the machine.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

In an embodiment, a method for generating an optimal motion control signal for at least one machine is disclosed. The method includes receiving an input from a user equipment. The input indicates a trajectory corresponding to a path to be followed by the at least one machine. The method includes splitting the trajectory into a plurality of sub-trajectories. Further, the method includes computing an order for each of the plurality of sub-trajectories based on at least one pattern associated with the splitting the trajectory into the plurality of sub-trajectories. The order indicates a sequence of each of the plurality of sub-trajectories. Further, the method includes formulating a plurality of factors associated with each of the plurality of sub-trajectories based on the computed order. The plurality of factors indicates the objective and constraint associated with each of the plurality of sub-trajectories. Further, the method includes determining solvability for each of the plurality of sub-trajectories based on the formulated plurality of factors. The solvability indicates an optimum operation of each of the plurality of sub-trajectories based on the objective and the constraint associated with each of the plurality of sub-trajectories. Furthermore, the method includes determining a plurality of constraint violations associated with at least one attribute of each sub-trajectory based on the determined solvability. The plurality of constraint violations indicates the violation of constraints associated with at least one attribute of each of the plurality of sub-trajectories. Furthermore, the method includes applying one or more remedial factors, based on the determined plurality of constraint violations. The one or more remedial factors indicate a signal processing technique. Furthermore, the method includes generating the optimal motion control signals for the at least one machine based on the applied one or more remedial factors.

Also disclosed herein is a system for generating an optimal motion control signal for at least one machine. The system includes a memory and at least one processor in communication with the memory. The at least one processor is configured to receive an input from a user equipment (UE), where the input indicates a trajectory corresponding to a path to be followed by the at least one machine. The at least one processor is configured to split the trajectory into a plurality of sub-trajectories. Further, the at least one processor is configured to compute an order for each of the plurality of sub-trajectories based on at least one pattern associated with the splitting the trajectory into the plurality of sub-trajectories. The order indicates a sequence of each of the plurality of sub-trajectories. Further, the at least one processor is configured to formulate a plurality of factors associated with each of the plurality of sub-trajectories based on the computed order. The plurality of factors indicates the objective, and constraint associated with each of the plurality of sub-trajectories. Further, the at least one processor is configured to determine solvability for each of the plurality of sub-trajectories based on the formulated plurality of factors. The solvability indicates an optimum operation of each of the plurality of sub-trajectories based on the objective and the constraint associated with each of the plurality of sub-trajectories. Furthermore, the at least one processor is configured to determine a plurality of constraint violations associated with at least one attribute of each sub-trajectory based on the determined solvability. The plurality of constraint violations indicates violation of constraints associated with at least one attribute of each of the plurality of sub-trajectories. Furthermore, the at least one processor is configured to apply one or more remedial factors, based on the determined plurality of constraint violations. Furthermore, the one or more remedial factors indicate a signal processing technique. The at least one processor is configured to generate the optimal motion control signals for the at least one machine based on the applied one or more remedial factors.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an environment comprising a system communicably coupled with a user equipment, in accordance with an embodiment of the present disclosure;

FIG. 2 illustrates a block diagram of the system for generating an optimal motion control signal for at least one machine, according to an embodiment of the present disclosure;

FIG. 3A illustrates a flow of an operation performed by the system, according to an embodiment of the present disclosure;

FIG. 3B illustrates a trajectory and a plurality of sub-trajectories, according to an embodiment of the present disclosure;

FIG. 3C illustrates a partial sub-division motion control solution profile of each sub-trajectory, according to an embodiment of the present disclosure;

FIG. 3D illustrates the optimal motion control signal as generated by the system, according to an embodiment of the present disclosure; and

FIGS. 4A-4B illustrate a flow chart of a method for generating the optimal motion control signal for the at least one machine, according to an embodiment of the present disclosure.

Further, skilled artisans will appreciate that those elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of modules that carry out a described function or functions. These modules, which may be referred to herein as units or blocks or the like, or may include blocks or units, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Embodiments will be described below in detail with reference to the accompanying drawings.

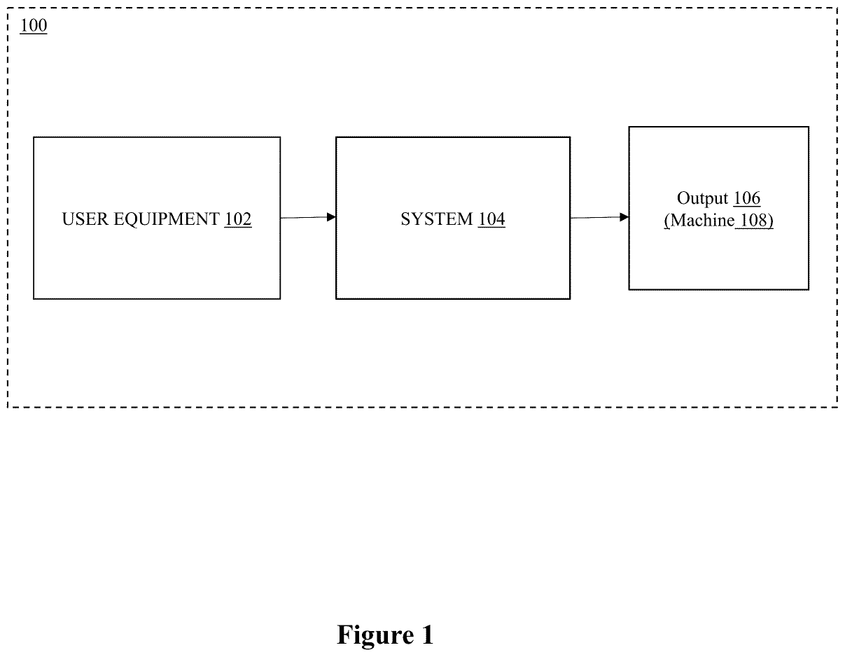

FIG. 1 illustrates an environment 100 comprising a system 104 communicably coupled with a user equipment 102, in accordance with an embodiment of the present disclosure. In an embodiment, the user equipment (UE) 102 may be a laptop, a computer, or any other electronic device compatible with generating output such that at least one machine 108, in an industry, operates based on the generated output, without departing from the scope of the present disclosure. The at least one machine 108 may be adapted to form a plurality of parts/components, based on the generated output, as required in the industry. In such an embodiment, the industry may be the automotive industry, home appliances manufacturing industry, etc. In such an embodiment, the outputs may be a signal corresponding to a trajectory to be followed by the at least one machine 108. The signal may be transmitted to the at least one machine 108 such that the at least one machine 108 may operate efficiently based on the received signal.

However, the at least one machine 108 experiences difficulty while traversing/following the trajectory. In that case, the system 104, coupled with the UE 102, may be configured to generate an output 106 indicative of an optimal motion control signal for the at least one machine 108. The at least one machine 108 may receive the output from the system 104 such that the at least one machine 108 may operate based on the received output.

Particularly, when the input is provided in the UE 102, the system 104 may be configured to receive the input and accordingly, generate the output 106 indicative of the optimal motion control signal for the at least one machine 108. The system 104 may generate the optimal motion control signal based on the input, where the input may indicate a trajectory corresponding to a path followed by the at least one machine 108. Thus, the system 104 eliminates the vibration or jerk movement of the at least one machine 108, thereby maintaining the efficiency of the at least one machine 108. The constructional and operational details of the system 104 are explained in the subsequent paragraphs.

In an embodiment, the system 104 may be communicatively coupled with the UE 102, without departing from the scope of the present disclosure. In another embodiment, the system 104 may be deployed in the UE 102, without departing from the scope of the present disclosure.

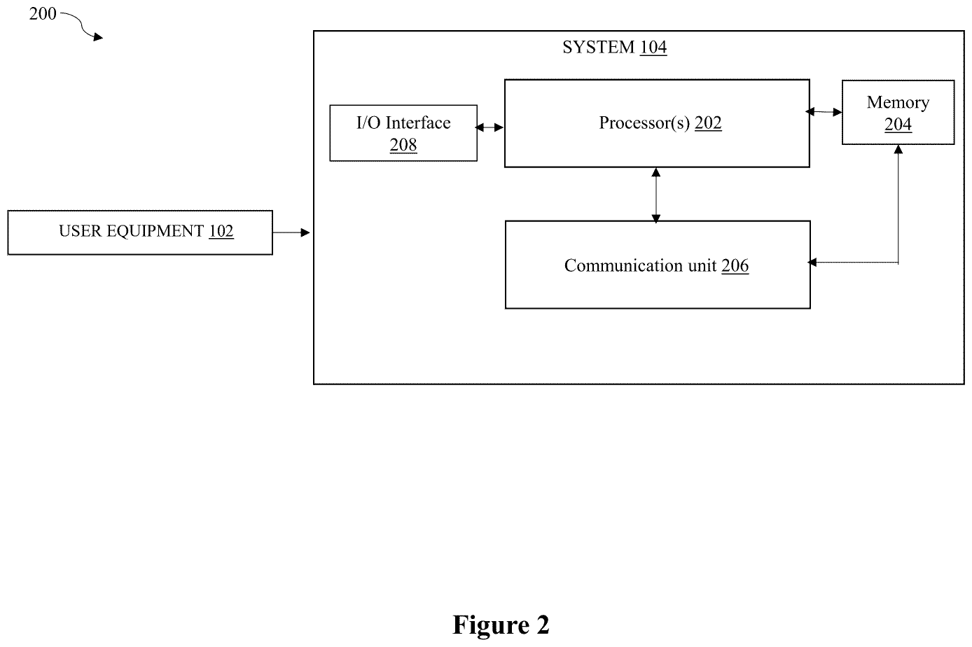

FIG. 2 illustrates a block diagram 200 of a system 104 for generating the optimal motion control signal for the at least one machine 108, according to an embodiment of the present disclosure.

The system 104 includes at least one processor (referred to herein as a processor) 202, a memory 204, a communication unit 206, and an input/output (I/O) interface 208. The system 104 may correspond to one of a server at a user location, a remote server, a user device, or any other electronic device. In one or more embodiments, the system 104 may include a combination of an electronic device and a server.

The processor(s) 202 can be a single processing unit or several units, all of which could include multiple computing units. The processor 202 may be in communication with the memory 204. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 204.

The memory 204 includes one or more computer-readable storage media. The memory 204 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that can, over time, change (e.g., in Random Access Memory (RAM) or cache.

The memory 204 may further include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The communication unit 206 is configured to communicate data or any other signal over a communication network. Further, the communication unit 206 may include a communication port, a communication interface, or a transceiver for sending and receiving signals from the system 104 via the communication network. The communication port or the communication interface may be a part of a processing unit or may be a separate component. The communication port may be created in software or may be a physical connection in hardware. The communication port may be configured to connect with the communication network, external media, the display, or any other components in the system 104, or combinations thereof. The connection with the communication network may be a physical connection, such as a wired Ethernet connection, or may be established wirelessly as discussed above. Likewise, the additional connections with other components of the system 104 may be physical or may be established wirelessly.

The I/O interface 208 refers to hardware or software components that enable communication between the system 104 and any other electronic device. The I/O interface 107 serves as a communication medium for exchanging information, commands, signals, or query responses with other devices or systems. The I/O interface 208 may be a part of the processor 202 or may be a separate component. The I/O interface 208 may be created in software or may be a physical connection in hardware. The I/O interface 208 may be configured to connect with an external network, external media, the display, or any other components, or combinations thereof. The external network may be a physical connection, such as a wired Ethernet connection, or may be established wirelessly.

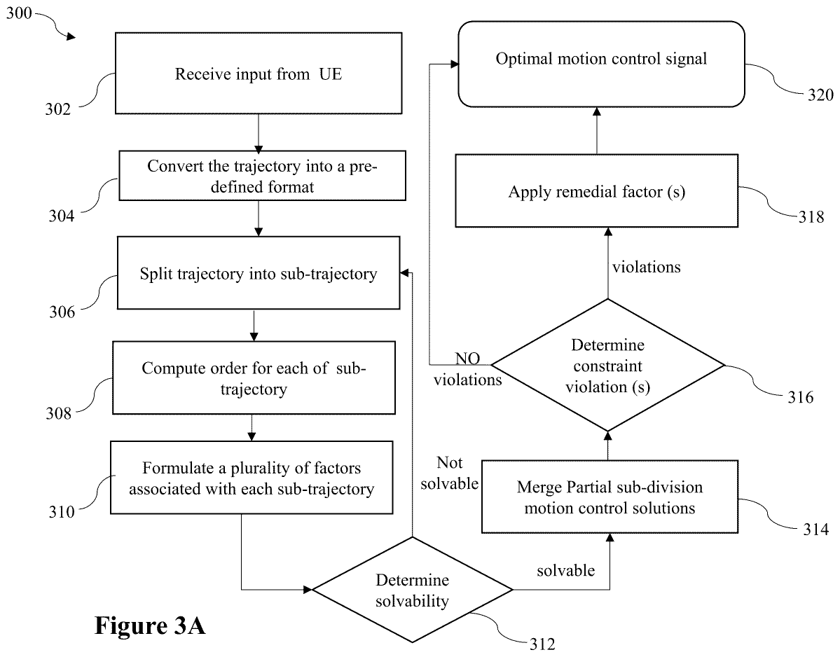

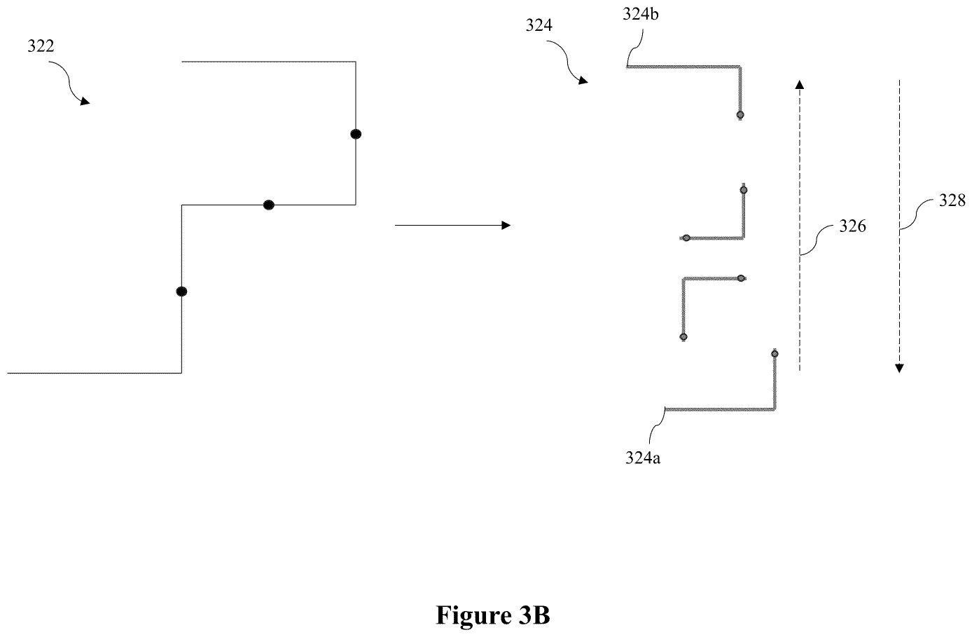

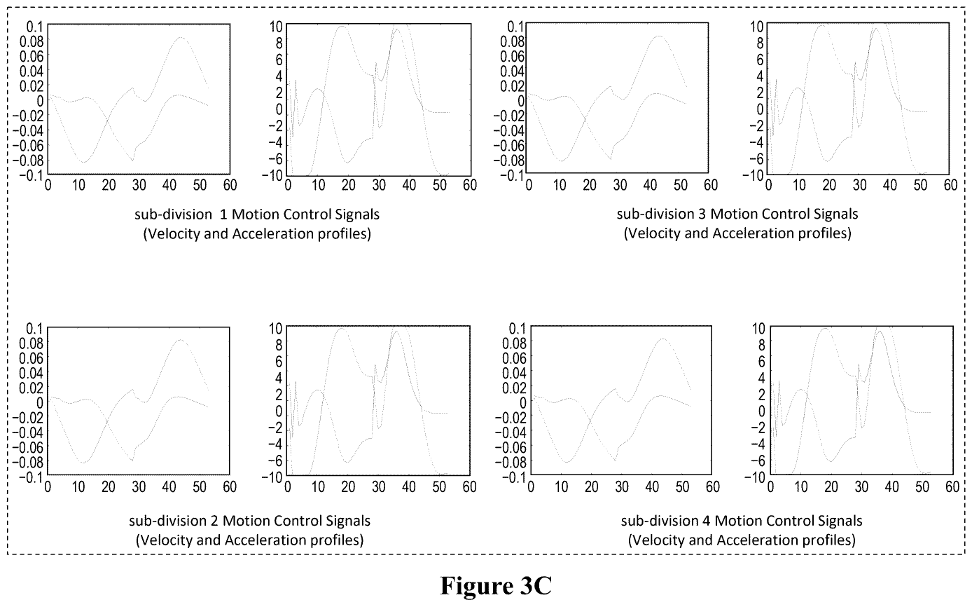

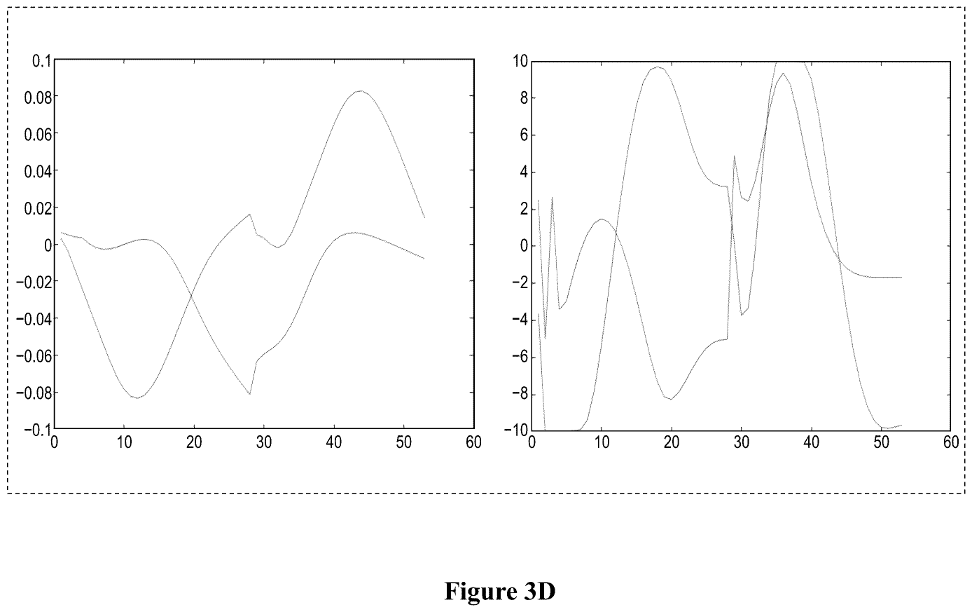

In one or more embodiments, one or more functions associated with the system 104 may be performed through the non-volatile memory, the volatile memory, and the processor 202 as explained in FIGS. 3A to 3D in conjunction with FIG. 2.

FIG. 3A illustrates a flow of an operation 300 performed by the system 104, according to an embodiment of the present disclosure. FIG. 3B illustrates a trajectory 322 and a plurality of sub-trajectories 324, according to an embodiment of the present disclosure. FIG. 3C illustrates a partial sub-division motion control solution profile of each sub-trajectory, according to an embodiment of the present disclosure. FIG. 3D illustrates the optimal motion control signal as generated by the system 104, according to an embodiment of the present disclosure.

In an embodiment, at block 302, the processor 202 may be configured to receive the input from the UE 102. In such an embodiment, the input may be provided by a user on the UE 102 with different techniques, for example, programming, from which the processor 202 may receive the input. In another embodiment, the input may be provided by the user on the UE 102, such that the processor 202 may be configured to receive the input, when the system 104 may be deployed in the UE 102, without departing from the scope of the present disclosure. In yet another embodiment, the input may be pre-stored in the UE 102, without departing from the scope of the present disclosure. The input indicates the trajectory 322 corresponding to the path to be followed by the at least one machine 108. The trajectory 322 may correspond to a pointset, GCode, or a function on the UE 102 which indicates the path to be followed by the at least one machine 108, without departing from the scope of the present disclosure. In an embodiment, the input may also include constraint, where the constraint may be defined as a boundary or limitation corresponding to the trajectory 322. The constraint may be complied by the at least one machine 108, while operating, to ensure efficient operation. The constraint may be also provided as the input by the user. The constraint may be kinematics constraint, and precision constraint, without departing from the scope of the present disclosure. Further, in another embodiment, inputs may also include a signal. In an example, the signal may correspond to a selection of points for splitting of the trajectory 322. In this example, the user may provide data corresponding to the signal via the programming. In another example, the signal may correspond to the setting of an interface to allow the user to specify a splitting point of the trajectory 322 such that the user may select the points for splitting the trajectory 322, manually, without departing from the scope of the present disclosure.

In one example, the trajectory 322 may be of different types, for example, a piece-wise linear trajectory. In the piecewise linear trajectory, a sequence of points is specified. For example, for a square trajectory, the sequence of points as specified may be {(0,0)→(0,1)→(1,1)→(1,0)→(0,0)}. Further, in another example, the sequence of points for a curve or circle trajectory may be determined by a formula:

$${x}^{2} + {y}^{2} = {r}^{2} \qquad ( i )$$

At block 304, the processor 202 may be configured to convert the trajectory 322 into a pre-defined format associated with the trajectory. The pre-defined format may be stored in the memory 204. The pre-defined format may have a functional specification that may retrieve points on the trajectory 322. In such an embodiment, the points may be retrieved at a predetermined distance from a start point of the trajectory 322. In an example, the predetermined distance may include a distance from the start point to a mid-point of the trajectory 322, an equal distance between the start point and an end point of the trajectory 322, etc. The retrieved points may be important to formulate a plurality of factors and derive differential formulations. Further, other specification formats, for example, the sequence of points for the square trajectory, the sequence of points for the curve or circle trajectory cannot be easily incorporated into the formulation operation as the mentioned specification formats do not include an explicit differential. In one example, for the square trajectory, the pre-defined format may be as follows:

$$Internal\_format ( 0 ) = ( 0 , 0 )$$

$$Internal\_format ( 1 ) = ( 0 , 1 )$$

$$Internal\_format ( 1.5 ) = ( 0.5 , 1 )$$

$$Internal\_format ( 2 ) = ( 1 , 1 )$$

At block 306, the processor 202, after converting the trajectory 322 into the pre-defined format, split the trajectory 322 into the plurality of sub-trajectories 324. In an embodiment, the plurality of sub-trajectories 324 may be formed, after splitting, in such a manner that at least one pattern may be defined, where the at least one pattern may be associated with the plurality of sub-trajectories 324. This configuration ensures ease of operation by the system 104 on the plurality of sub-trajectories 324. In an example, the plurality of sub-trajectories 324 may be formed by at least one of a plurality of predetermined operations, for example, splitting at the mid-points of the trajectory 322, splitting at equal distances between the start point and the end point of the trajectory 322. Additionally, a plurality of parameters, for example, separating or discarding known complex sub-trajectory that may cause vibrations or considering known sub-trajectory for which pre-defined formulas may be employed, is considered for splitting the trajectory 322. These considerations may vary based on each task, operational complexities related to each task, depth of domain expertise available related to each task, etc.

At block 308, the processor 202 may be configured to compute an order for each of the plurality of sub-trajectories 324 based on the at least one pattern associated with the splitting of the trajectory 322 into the plurality of sub-trajectories 324. The order may indicate a sequence of each of the plurality of sub-trajectories 324. In an embodiment, the sequence indicates a sequence of execution of each of the plurality of sub-trajectories 324. In an example, the processor 202 may be configured to compute the order for each of the plurality of sub-trajectories 324 by a gradient (derivative) based optimization technique generated through the differential formulations, without departing from the scope of the present disclosure. Particularly, the at least one pattern indicates a formation initiating from the start point 324a of an initial sub-trajectory from among the plurality of sub-trajectories 324 to an end point 324b of a last sub-trajectory from among the plurality of sub-trajectories (referred to herein as a straight pattern 326). Further, the start point 324a may be determined by a pre-defined technique and the remaining sub-trajectories may be further positioned according to the proximity of each sub-trajectory with respect to the start point 324a. In one example, the pre-defined technique may include a selection of a first point of the initial sub-trajectory as the start point or the selection of the end point of the last sub-trajectory as the start point. Further, in an embodiment, the at least one pattern indicates a formation initiating from the end point 324b of the last sub-trajectory to the start point 324a of the initial sub-trajectory (referred to herein as a reverse pattern 328), without departing from the scope of the present disclosure. Thus, once the at least one pattern associated with the plurality for sub-trajectories 324 is defined, then the processor 202 may be configured to compute the order for each of the plurality of sub-trajectories 324 based on the at least one pattern.

At block 310, the processor 202 may be configured to formulate a plurality of factors associated with each of the plurality of sub-trajectories based on the computed order. Further, the formulation may be performed by the processor 204 through different predetermined techniques, for example, SQP technique. In an embodiment, the plurality of factors may indicate the objective, and the constraint associated with each of the plurality of sub-trajectories 324. In an embodiment, the objective may refer to low error, low vibration, low takt time, etc, without departing from the scope of the present disclosure. Further, an optimized motion control signal between consecutive sub-trajectories from the plurality of sub-trajectories 324 is incorporated as the constraint of the plurality of factors for avoiding abrupt jumps in the motion control signals and resulting jerks. Further, the constraint associated with each sub-trajectory is formulated in a predetermined manner, i.e., in a dynamic manner, without departing from the scope of the present disclosure. The dynamic manner may be referred to as solving of at least one sub-trajectory, selected randomly, from among the order for each of the plurality of sub-trajectories 324 which may also affect the objective and the solving of the constraint associated with each of the plurality of sub-trajectories 324. Particularly, once the at least one sub-trajectory may be solved, thus, the motion control signals of each of remaining sub-trajectories from the plurality of sub-trajectories 324 may be the constraint of the plurality of factors. The constraint thereby affects the objectives on each of the remaining sub-trajectories, without departing from the scope of the present disclosure. In one example, the sequence of each sub-trajectory, from the computed order, may be provided as 1-2-3-4-5. So, if the sub-trajectory at sequence 3 is initially solved, then the constraint of the sub-trajectory at sequences 2 and 4 may be calculated based on the solution obtained for the sub-trajectory at sequence 3. This indicates the formulation of the constraint in the dynamic manner. The constraint may be, but is not limited to, kinematic constraints, and precision constraint, without departing from the scope of the present disclosure. The kinematic constraint may be defined as a constraint associated with a motion of the at least one machine 108 while traversing each sub-trajectory. The precision constraint may be a constraint associated with the motion of the at least one machine 108 to ensure accurate and repeatable performance. Thus, based on the different predetermined techniques, the processor 202 may be configured to formulate the plurality of factors.

In one example, for the trajectory, the initial and final velocity should be 0. Further, once the trajectory 322 is split into the plurality of sub-trajectories 324, then a final sub-trajectory is considered from the plurality of sub-trajectories 324. The initial velocity for the final sub-trajectory cannot be zero (0) as the motion from the preceding sub-trajectory must be continued. Further, the final velocity of the final sub-trajectory is still zero (0). Therefore, the constraints associated with the remaining sub-trajectories are formulated in such a manner that the final velocity of the sub-trajectory is still zero (0). Thus, the process as explained in the example indicates the formulation of the constraint in the dynamic manner.

At block 312, the processor 202 may be configured to determine solvability for each of the plurality of sub-trajectories 324 based on the formulated plurality of factors. The solvability indicates an optimum operation of each of the plurality of sub-trajectories 324 based on the objective and the constraint associated with each of the plurality of sub-trajectories 324. In an embodiment, the optimum operation indicates that each sub-trajectory may be easily traversable by the at least one machine 108, without departing from the scope of the present disclosure. In an embodiment, the processor 202 may be configured to correlate the formulated plurality of factors with a plurality of predetermined factors associated with each sub-trajectory. The solvability may be implemented in phases of initialization, solver iterations, and termination of the operation, where the termination may provide information related to the solvability. Additionally, the termination with an error indicates non-solvability. Further, the processor 202 may be configured to determine the solvability of each sub-trajectory, when the formulated plurality of factors is available in the plurality of predetermined factors. In one example, the plurality of predetermined factors associated with each sub-trajectory may include a constraint of +−5. Further, the formulated plurality of factors associated with each sub-trajectory may include a constraint of +−3 which is available in the plurality of predetermined factors. Thus, in this case, each sub-trajectory is solvable. In another embodiment, the processor 202 may determine the solvability by a plurality of predetermined methods, for example, theoretical method, method disclosing achievability of all constraints simultaneously, convergence of the computed order, without departing from the scope of the present disclosure.

Further, in an embodiment, the processor 202 determines that the formulated plurality of factors is not available in the plurality of predetermined factors, then the processor 202 may again perform the operation as discussed in block 306.

Further, once the solvability is determined, then at block 314, the processor 202 may be configured to merge a partial sub-division motion control solution profile, as shown in FIG. 3C, of each sub-trajectory based on the solvability of each of the plurality of sub-trajectories 324. In an embodiment, the partial sub-division motion control solution profile may indicate a velocity and acceleration profile of each sub-trajectory. In an embodiment, the processor 202 may merge the partial sub-division motion by a plurality of operations, for example, concatenating at least one of a velocity profile and an acceleration profile of each sub-trajectory in a cascading sequence, without departing from the scope of the present disclosure. The velocity profile of each sub-trajectory may be defined as a plot of a speed or velocity that is to be considered by the at least one machine 108 while traversing on each sub-trajectory. The acceleration profile of each sub-trajectory may be defined as a variation of acceleration over time that is to be considered by the at least one machine 108 while traversing on each sub-trajectory.

At block 316, the processor 202 may be configured to determine a plurality of constraint violations associated with at least one attribute of each sub-trajectory based on the determined solvability. The plurality of constraint violations may indicate violation of constraints associated with at least one attribute of each of the plurality of sub-trajectories. In an embodiment, the processor 202 may be configured to determine the plurality of constraint violations associated with the at least one attribute of each of the plurality of sub-trajectories 324, when a partial sub-division motion control solution profile of at least one succeeding sub-trajectory varies from a partial sub-division motion control solution profile of at least one preceding sub-trajectory after merging. In an embodiment, the at least one attribute may include at least one of a position, a velocity, an acceleration associated with each of the plurality of sub-trajectories 324.

In one example, there may be several types of constraints on the at least one attributes, for example, the position, the velocity, the acceleration, etc. For the position constraint, a tolerance band around the intended trajectory is provided by the system 104. Thus, after merging the partial sub-division motion control solution profile of each sub-trajectory, if the partial sub-division motion control solution profile results in deviating from the tolerance band, then the constraint on the position is violated. The position constraint violation is defined as deviation of the position of each sub-trajectory beyond the tolerance band around a planned/pre-determined position of each sub-trajectory. For other constraints on the velocity or the acceleration, a range of minimum and maximum values is stored in the memory of the system 104. Thus, after merging the partial sub-division motion control solution profile, if the profile results in deviating from the minimum value and the maximum value, then constraint on the velocity and the acceleration is violated.

At block 318, the processor 202 may be configured to apply one or more remedial factors, based on the determined plurality of constraint violations, when the processor 202 determines that the plurality of constraint violations has occurred. The one or more remedial factors may indicate a signal processing technique. The one or more remedial factors may be configured to, when applied, match the partial sub-division motion control solution profile of at least one succeeding sub-trajectory with the partial sub-division motion control solution profile of at least one preceding sub-trajectory, ensuring ease of generation of the optimal motion control signal by the processor 202. In such an embodiment, the signal processing technique may include, but is not limited to, waveform filtering to eliminate abrupt changes in a waveform corresponding to each sub-trajectory. Further, the one or more remedial factors may also include a notch filtering technique, or geometric technique, without departing from the scope of the present disclosure.

At block 320, the processor 202 may be configured to generate the optimal motion control signals as shown in FIG. 3D, for the at least one machine 108 based on the applied one or more remedial factors.

Further, in an embodiment, when the processor 202 determines that the plurality of constraint violations may not have occurred, then the processor 202 may be configured to generate the optimal motion control signal as shown in FIG. 3D. In an embodiment, the optimal motion control signal may indicate the optimal velocity profile and the acceleration profile for the at least one machine 108 such that the at least one machine 108 may traverse on the trajectory 322 efficiently.

In an exemplary implementation, the at least one machine 108 may be adapted to follow the path/trajectory 322 in a XY axis as provided on a platform (two-axis platform) to form any part/component. Thus, the system 104 generates the optimal motion control signal for the at least one machine 108 such that the at least one machine 108 follows the trajectory 322 optimally. The optimal motion control signal is generated while considering an error tolerance of approximately 10 micron and acceleration of 100 m/s². Particularly, the system 104 generates the optimal motion control signal while considering the error tolerance of approximately 10 microns and 2 orders of magnitude which results in a reduction in the vibration and also eliminates jerking movement. Further, the system 104 also ensures a reduction of approximately 30% in compute time as compared to undivided full trajectory optimization.

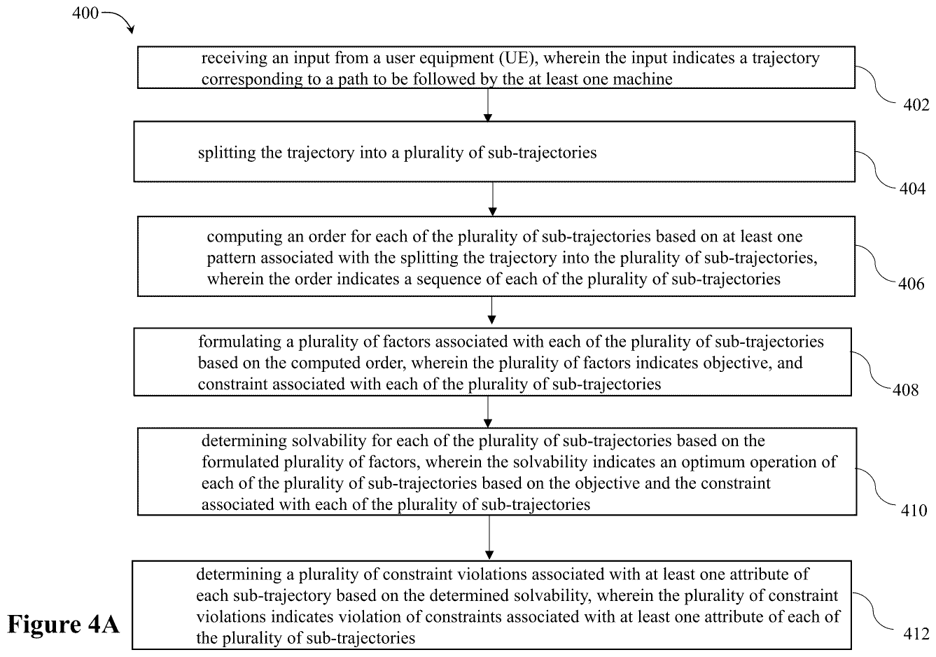

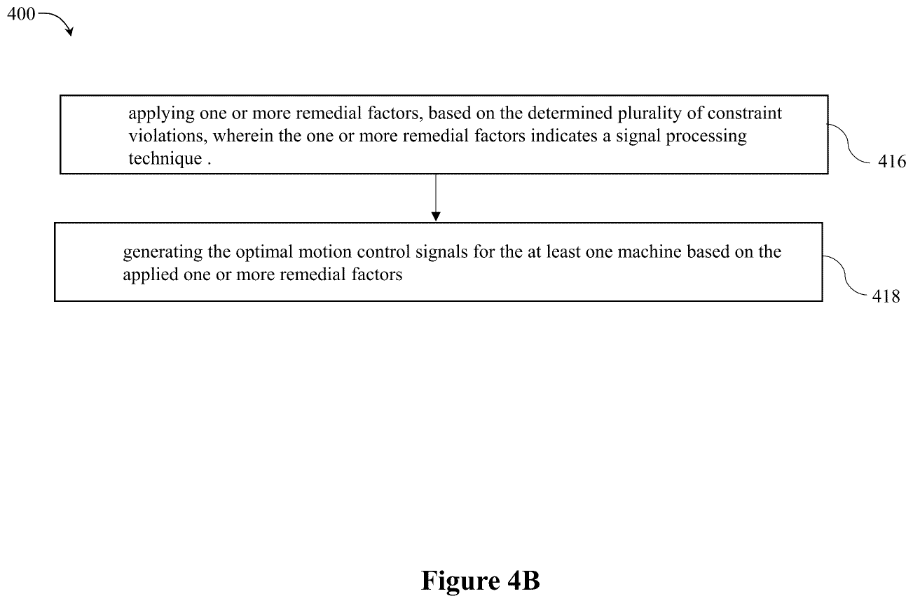

FIGS. 4A-4B illustrate a flow chart of a method 400 for generating the optimal motion control signal for the at least one machine 108, according to an embodiment of the present disclosure. The method 400 includes a series of steps 402 through 412 performed by the processor 202.

At step 402, the method 400 includes receiving the input from the UE 102. The input may indicate the trajectory 322 corresponding to the path to be followed by the at least one machine 108.

At step 404, the method 400 includes splitting the trajectory 322 into the plurality of sub-trajectories 324. Prior to splitting the trajectory 322 into the plurality of sub-trajectories 324. The method 400 includes converting the trajectory into a pre-defined format associated with the trajectory 322. The pre-defined format may be pre-stored in the memory 204.

At step 406, the method 400 includes computing the order for each of the plurality of sub-trajectories 324 based on the at least one pattern associated with the splitting the trajectory 322 into the plurality of sub-trajectories 324. The order indicates the sequence of each of the plurality of sub-trajectories 324. The at least one pattern may indicate the pattern initiating from the start point 324a of the initial sub-trajectory from the plurality of sub-trajectories 324 to the end point 324b of the last sub-trajectory from the plurality of sub-trajectories 324.

At step 408, the method 400 includes formulating the plurality of factors associated with each of the plurality of sub-trajectories 324 based on the computed order. The plurality of factors indicates objective, and constraint associated with each of the plurality of sub-trajectories 324. The constraint associated with each of the plurality of sub-trajectories 324 may be formulated in the pre-determined manner.

At step 410, the method 400 includes determining solvability for each of the plurality of sub-trajectories 324 based on the formulated plurality of factors. The solvability may indicate the optimum operation of each of the plurality of sub-trajectories 324 based on the objective and the constraint associated with each of the plurality of sub-trajectories 324. The method 400 includes correlating the formulated plurality of factors with the plurality of predetermined factors associated with each sub-trajectory. The method 400 includes determining the solvability of each sub-trajectory, when the formulated plurality of factors may be available in the plurality of predetermined factors.

The method 400 includes merging the partial sub-division motion control solution profile of each sub-trajectory, based on the solvability of each of the plurality of sub-trajectories 324.

At step 412, the method 400 includes determining the plurality of constraint violations associated with the at least one attribute of each sub-trajectory based on the determined solvability. The plurality of constraint violations indicates violation of constraints associated with at least one attribute of each of the plurality of sub-trajectories 324. The method 400 includes determining the plurality of constraint violations associated with the at least one attribute of each of the plurality of sub-trajectories 324, when the partial sub-division motion control solution profile of at least one succeeding sub-trajectory varies from the partial sub-division motion control solution profile of at least one preceding sub-trajectory after merging. The at least one attribute may include at least one of the position, the velocity, the acceleration associated with each of the plurality of sub-trajectories 324.

At step 414, the method 400 includes applying one or more remedial factors, based on the determined plurality of constraint violations. The one or more remedial factors indicate the signal processing technique.

At step 416, the method 400 includes generating the optimal motion control signals for the at least one machine 108 based on the applied one or more remedial factors.

While the above discussed steps in FIG. 5A-5B are shown and described in a particular sequence, the steps may occur in variations to the sequence in accordance with various embodiments. Further, a detailed description related to the various steps of FIGS. 5A-5B is already covered in the description related to FIGS. 2 to 3D and is omitted herein for the sake of brevity.

The system 104 and the method 400 disclosed herein ensure the generation of the optimal motion control signals for the at least one machine 108. The optimal motion control signal as generated ensures optimal takt-time and complies with precision (error tolerance) and vibration constraint. This results in the elimination of the vibration and the related jerking movement of the at least one machine 108, thereby resulting in the optimum traversing of the at least one machine 108 on the trajectory 322. This ensures the optimum efficiency of the at least one machine. Particularly, the ordering for each of the plurality of sub-trajectories 324 ensures dynamic calculation of boundary conditions and dynamic specification of the constraints associated with each of the plurality of sub-trajectories. This ensures the reusing of manually optimized control signals, precomputed control signals, or new plurality of factors formulation using the boundary conditions and dynamic specification of the constraints. The splitting of the trajectory 322 in the plurality of sub-trajectories 324 ensures that each sub-trajectory is optimizable under vibration-limitation and high-precision constraint. The formulation of the plurality of factors associated with each of the plurality of sub-trajectories 324 ensures that the constraints are formulated in the dynamic manner. This ensures optimal transition motion control at points of the division of the plurality of sub-trajectories 324. The solvability of the sub-trajectories 334 results in increasing the efficiency of the at least one machine 108 while following the complete trajectory to perform a desired task. The merging of the partial sub-division motion control solution profile ensures optimal transition at division points of each sub-trajectory and verification and remediation of any constraint violations.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for generating an optimal motion control signal for at least one machine, the method comprising:
receiving an input from a user equipment (UE), wherein the input indicates a trajectory corresponding to a path to be followed by the at least one machine;
splitting the trajectory into a plurality of sub-trajectories;
computing an order for each of the plurality of sub-trajectories based on at least one pattern associated with the splitting the trajectory into the plurality of sub-trajectories, wherein the order indicates a sequence of each of the plurality of sub-trajectories;
formulating a plurality of factors associated with each of the plurality of sub-trajectories based on the computed order, wherein the plurality of factors indicates objective, and constraint associated with each of the plurality of sub-trajectories;
determining solvability for each of the plurality of sub-trajectories based on the formulated plurality of factors, wherein the solvability indicates an optimum operation of each of the plurality of sub-trajectories based on the objective and the constraint associated with each of the plurality of sub-trajectories;
determining a plurality of constraint violations associated with at least one attribute of each sub-trajectory based on the determined solvability, wherein the plurality of constraint violations indicates violation of constraints associated with at least one attribute of each of the plurality of sub-trajectories;
applying one or more remedial factors, based on the determined plurality of constraint violations, wherein the one or more remedial factors indicates a signal processing technique; and
generating the optimal motion control signals for the at least one machine based on the applied one or more remedial factors.

2. The method as claimed in claim 1, wherein prior to splitting the trajectory into the plurality of sub-trajectories, the method comprising:
converting the trajectory into a pre-defined format associated with the trajectory, wherein the pre-defined format is pre-stored in a memory.

3. The method as claimed in claim 1, wherein the at least one pattern indicates a pattern initiating from a start point of an initial sub-trajectory from the plurality of sub-trajectories to an end point of a last sub-trajectory from the plurality of sub-trajectories.

4. The method as claimed in claim 1, wherein the constraint associated with each sub-trajectory is formulated in a predetermined manner.

5. The method as claimed in claim 1, wherein for determining the solvability, the method further comprising:
correlating the formulated plurality of factors with a plurality of predetermined factors associated with each sub-trajectory; and
determining the solvability of each sub-trajectory, when the formulated plurality of factors is available in the plurality of predetermined factors.

6. The method as claimed in claim 5, wherein the method further comprising:
merging a partial sub-division motion control solution profile of each sub-trajectory, based on the solvability of each of the plurality of sub-trajectories.

7. The method as claimed in claim 6, wherein the method further comprising:
determining the plurality of constraint violations associated with the at least one attribute of each of the plurality of sub-trajectories, when a partial sub-division motion control solution profile of at least one succeeding sub-trajectory varies from a partial sub-division motion control solution profile of at least one preceding sub-trajectory after merging.

8. The method as claimed in claim 7, wherein the at least one attribute comprises at least one of a position, a velocity, or an acceleration associated with each of the plurality of sub-trajectories.

9. A system for generating an optimal motion control signal for at least one machine, the system comprising:
a memory; and
at least one processor in communication with the memory, wherein the at least one processor is configured to:
receive an input from a user equipment (UE), wherein the input indicates a trajectory corresponding to a path to be followed by the at least one machine;
split the trajectory into a plurality of sub-trajectories;
compute an order for each of the plurality of sub-trajectories based on at least one pattern associated with the splitting the trajectory into the plurality of sub-trajectories, wherein the order indicates a sequence of each of the plurality of sub-trajectories;
formulate a plurality of factors associated with each of the plurality of sub-trajectories based on the computed order, wherein the plurality of factors indicates objective, and constraint associated with each of the plurality of sub-trajectories;
determine solvability for each of the plurality of sub-trajectories based on the formulated plurality of factors, wherein the solvability indicates an optimum operation of each of the plurality of sub-trajectories based on the objective and the constraint associated with each of the plurality of sub-trajectories;
determine a plurality of constraint violations associated with at least one attribute of each sub-trajectory based on the determined solvability, wherein the plurality of constraint violations indicates violation of constraints associated with at least one attribute of each of the plurality of sub-trajectories;
apply one or more remedial factors, based on the determined plurality of constraint violations, wherein the one or more remedial factors indicates a signal processing technique; and
generate the optimal motion control signals for the at least one machine based on the applied one or more remedial factors.

10. The system as claimed in claim 9, wherein prior to splitting the trajectory into the plurality of sub-trajectories, the at least one processor is configured to:
convert the trajectory into a pre-defined format associated with the trajectory, wherein the pre-defined format is pre-stored in the memory.

11. The system as claimed in claim 9, wherein the at least one pattern indicates a pattern initiating from a start point of an initial sub-trajectory from the plurality of sub-trajectories to an end point of a last sub-trajectory from the plurality of sub-trajectories.

12. The system as claimed in claim 9, wherein the constraint associated with each sub-trajectory is formulated in a predetermined manner.

13. The system as claimed in claim 9, wherein for determining the solvability, the at least one processor is configured to:
correlate the formulated plurality of factors with a plurality of predetermined factors associated with each sub-trajectory; and
determine the solvability of each sub-trajectory, when the formulated plurality of factors is available in the plurality of predetermined factors.

14. The system as claimed in claim 13, wherein the at least one processor is configured to:
merge a partial sub-division motion control solution profile of each sub-trajectory, based on the solvability of each of the plurality of sub-trajectories.

15. The system as claimed in claim 14, wherein the at least one processor is configured to:
determine the plurality of constraint violations associated with the at least one attribute of each of the plurality of sub-trajectories, when a partial sub-division motion control solution profile of at least one succeeding sub-trajectory varies from a partial sub-division motion control solution profile of at least one preceding sub-trajectory after merging.

16. The system as claimed in claim 15, wherein the at least one attribute comprises at least one of a position, a velocity, and an acceleration associated with each of the plurality of sub-trajectories.
